(19) United States
(12) Patent Application Publication
(10) Pub. No.: US 2009/0024537 A1
(43) Pub. Date: Jan. 22, 2009

(54) Exchange-traded fund and process for trading same

(76) Inventors: Jan van Eck, Rye, NY (US); Joseph LaCorte, Garden City, NY (US)

Correspondence Address: CLIFFORD CHANCE US LLP, 31 WEST 52ND STREET, NEW YORK, NY, 10019-6131, US

(21) Appl. No.: 11/880,282

(22) Filed: Jul. 20, 2007

(51) Int. Cl. G06Q 40/00

(52) U.S. Cl. 705/36 R

(57) ABSTRACT

The invention provides an exchange-traded fund for the trading of relatively illiquid securities and a process for forming and trading the same. The exchange-traded fund includes securities that are component securities of an Underlying Index and securities that are not component securities, thereby affording Authorized Participants the flexibility to designate securities within each category for inclusion in a portfolio deposit for the creation of a Creation Unit. This approach is necessitated by the relatively illiquid securities such as municipal bonds that lack sufficient liquidity for easy assembly in the amounts necessary for the in-kind creation or redemption of Creation Units for typical exchange-traded funds. This approach facilitates the ability of Authorized Participants to assemble a portfolio deposit and thereby allow for the effective functioning of an arbitrage process, while simultaneously enhancing the ability of the exchange-traded fund to track the applicable Underlying Index.

### FIELD OF THE INVENTION

This invention relates to Exchange Traded Funds that seek to replicate the performance, before fees and expenses, of certain market indices. More specifically, the invention relates to Exchange Traded Funds that seek to replicate the performance, before fees and expenses, of indices comprised substantially of relatively illiquid securities such as municipal bonds.

### BACKGROUND OF THE INVENTION

An exchange-traded fund (hereinafter an “ETF”), is an open-end fund that can be traded on an exchange throughout the day in much the way a stock can. Shares, or an ETF “share”, may be purchased and redeemed from the ETF at net asset value on a daily basis, but only in large block size. These blocks are typically referred to as Creation Units and generally consist of 50,000 or more shares. Purchases and redemptions are generally effected by an in-kind tender of a specified basket of securities.

ETFs typically seek to replicate the performance, before fees and expenses, of a specified stock or fixed income index. At present, however, there is no practiced ETF that seeks to track the performance of indices comprised substantially of relatively illiquid securities. This is attributable in large part to the difficulties in assembling relatively illiquid securities in amounts necessary for the in-kind creation or redemption of shares of an ETF.

The SEC has defined an illiquid security as a security that cannot be disposed of within 7 days in the ordinary course of business at approximately the amount at which the company has valued the instrument. The SEC uses this definition for the purposes of a 15 percent limit on investment by open-end investment companies in illiquid securities. A “relatively illiquid security” is generally more liquid than an SEC defined illiquid security, yet is generally more illiquid than a truly liquid security. Included in the category of relatively illiquid securities are municipal bonds and asset backed securities. Regarding municipal bonds, the U.S. bond market can be divided into four market segments: Treasury, government agency, corporate/foreign and municipal. The Treasury bond market is a multi-trillion dollar market of securities issued by the U.S. government, while the U.S. government agency market consists of bonds issued by various federal agencies such as the Government National Mortgage Association, or GNMA. Further, the corporate/foreign bond market consists of bonds issued by companies seeking to raise capital for plant, equipment, or other types of investments.

The municipal bond market consists of bonds issued by states, municipalities, and state-created taxing authorities. Municipal bond proceeds are used by municipalities to finance projects ranging from school, road and sewer construction to industrial development. In the past, municipal bond buyers and sellers consisted primarily of individuals who were attracted to the tax benefits of municipal bonds (municipal bonds pay interest exempt from federal and sometimes local taxation).

These types of bonds can be grouped in several ways. The market can generally be divided as: pre-refunded or escrowed-to-maturity, Insured, General Obligations, Certificates of Participation, Higher Education, Student Loans, Other Education, Hospitals, Lifecare, Nursing Homes, Industrial Development Revenue bonds/Pollution Control Revenue bonds, Multi-Family Housing, Single-Family Housing, Airports, Port Authorities, Toll Roads, Public Power, Resource Recovery and Water/Sewer.

As a result of the wide number of municipal bonds and categories, the municipal bond market is very fragmented. The municipal bond market is significantly more diverse and larger than the stock and corporate/foreign bond markets in terms of the numbers of issuers. The stock market, for example, consists of approximately 8,500 issuers that trade electronically or on the New York, NASDAQ and American Stock Exchanges. The corporate bond market consists of about 7,300 issuers. By contrast, the municipal bond market is comprised of over 50,000 issuers and has about 1.3 million different securities outstanding.

Households have long been the majority owners of municipal debt, holding approximately $855 billion, or about 37% of the total amount of outstanding municipal debt, while money market funds and mutual funds hold approximately 15.11% and 14.34% of the total amount of municipal debt, respectively. Notwithstanding the overall size of the U.S. municipal bond market, investors who wish to trade large amounts of specific municipal bonds can encounter liquidity difficulties, based on the following concerns:
The secondary trading market in such securities is mostly a retail market for individuals, resulting in prices that may be substantially higher than an institutional buyer could obtain for large amounts of a particular issue. Secondary trading is often light and illiquid (estimated at $20 billion daily versus $600 billion in U.S. Treasury trading).
Liquidity, with respect to large amounts of municipal securities, is most often readily available for new issues, whose size generally varies from $3 million to $1-2 billion. The frequency—and thus availability—of such new issues, however, can be irregular.

Thus, there remains a need in the art for an ETF that tracks the performance of indices comprised substantially of relatively illiquid securities such as municipal bonds and a process that facilitates the ability of ETF sponsors to launch ETFs based on indices comprised substantially of relatively illiquid securities.

### SUMMARY OF THE INVENTION

Therefore it is an object of the invention to provide a mechanism to facilitate the in-kind creation and redemption of shares of an ETF which seeks to replicate, before fees and expenses, the performance of an index or indices comprised substantially of relatively illiquid securities.

It is a further object of the invention to provide a process for dividing the underlying index into manageable risk categories based on risk and return characteristics of the index and treating each characteristic as if it were a separate sub-index or category, constructing a portfolio of securities that represent each of these categories, wherein a portion of the securities are similar securities, wherein the similar securities are securities from outside the underlying index and have characteristics similar to the securities that are represented in the underlying index.

It is a further object of the invention to provide a process to facilitate in-kind creation and redemption of shares of an ETF which seeks to replicate the performance of an index or indices comprised substantially of relatively illiquid securities including the steps of: identifying an underlying index or indices having a multiplicity of relatively illiquid component securities, assigning risk and return characteristics to the relatively illiquid component securities, creating a list of categories, the categories each generally corresponding to a representative subset of component securities having like risk and return characteristics, and exchanging one or a multiplicity of Creation Units for a basket of securities, wherein the risk and return characteristics of the basket of securities for each Creation Unit comprise individual securities that meet the risk and return characteristics of an individual category such that all of the categories are represented in the basket of securities.

It is a further object of the invention to provide a process to facilitate in-kind creation and redemption of shares of an ETF which seeks to replicate the performance of an index or indices comprised substantially of relatively illiquid securities, including the steps of determining a multiplicity of categories based on risk and return characteristics of relatively illiquid securities, and exchanging one relatively illiquid security contribution from each category for a Creation Unit, each relatively illiquid security having in-kind risk and return characteristics as the corresponding category.

It is a further object of the invention to provide a fund for facilitating in-kind creation and redemption of shares of an exchange-traded fund, the fund comprising a multiplicity of shares relating to categories based on risk and return characteristics of relatively illiquid component securities.

These and other additional features, objects and advantages of the invention will become apparent to one skilled in the art by reading the following detailed description of the invention and corresponding drawings.

### DESCRIPTION OF THE DRAWINGS

FIG. 1 is a diagram of a creation process for Creation Units.

FIG. 2 is a diagram of a redemption process of Creation Units.

FIG. 3 is a table of an exchange-traded fund creation order process.

### DETAILED DESCRIPTION OF THE INVENTION

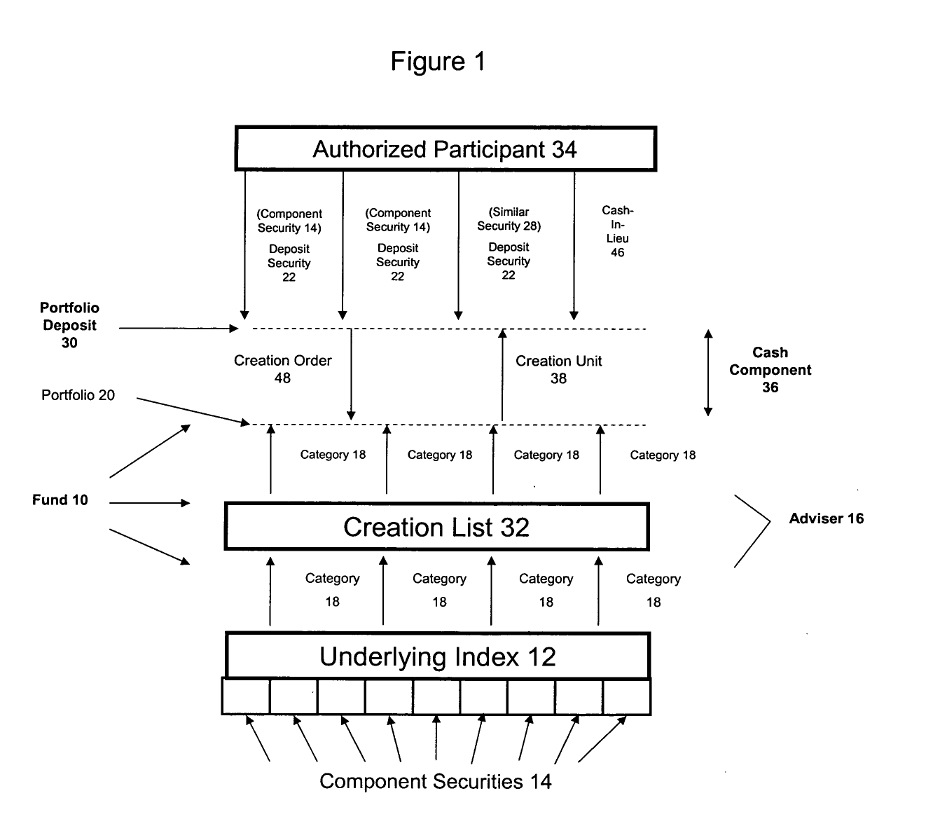

The invention provides a mechanism in which the categories of relatively illiquid securities that may comprise a creation and redemption basket of securities are published in lieu of a fixed list of specific securities. An exchange-traded fund 10, hereinafter the “Fund”, for the trading of illiquid securities such as municipal bonds is shown in FIG. 1. While the term Fund is singular, it is understood that a plurality of Funds 10 may be offered on an exchange. Further, any Fund 10 may be taxable, tax-exempt or a combination. Fund 10 seeks to track the performance, before fees and expenses, of one or a multiplicity of indices that track or correlate to relatively illiquid securities, wherein the indices tracked by Fund 10 are Underlying Indices 12. In the preferred embodiment, the Underlying Indices 12 track or correlate to municipal bonds. In further embodiments, Fund 10 can track the performance of Underlying Indices 12 that track or correlate to other types of relatively illiquid securities, such as asset backed securities, including but not limited to ABS, 144As, MSS, CDOs, or CLOs. Each Fund 10 will invest in some or all Component Securities 14 of the specified Underlying Index 12 (“Component Securities” 14). In preferred embodiments, Fund 10 is intended to have a tracking error relative to the performance of its Underlying Index 12, over time, of no more than five percent (5%).

In some embodiments, Fund 10 may fully replicate Underlying Index 12, wherein an Adviser 16 of Fund 10 invests in substantially all of Component Securities 14 in its Underlying Index 12 in the same approximate proportions as in the Underlying Index 12. In alternate embodiments, Fund 10 and/or an Adviser 16 of Fund 10 may use a “representative sampling” strategy to track its Underlying Index 12. In preferred embodiments, Fund 10 will utilize the representative sampling strategy and generally will hold a basket of certain, but not all Component Securities 14 of its Underlying Index 12. For the purposes of this application, Adviser 16 may also be a Sub-Adviser.

When using a representative sampling strategy, Adviser 16 will attempt to match risk and return characteristics of the Fund's Portfolio 20 to risk and return characteristics of the Underlying Index 12. Given the multiple dimensions of risk within a bond portfolio (e.g., credit, sector, issuer, maturity and liquidity), sampling and risk control is a complex process. As part of this process, Adviser 16 will generally divide the portion of the fixed income market represented by Underlying Index 12 into “categories” according to certain parameters that determine a relatively illiquid security's risk and expected return.

Category 18 or Categories 18, therefore, are a grouping of securities with like characteristics, including rating, coupon and maturity, deemed acceptable by Adviser 16 for investment in a Fund's Portfolio 20. In the creation process, the acceptable securities are eligible Deposit Securities 22. In the redemption process, the acceptable securities are Fund Securities 50. To create the categories, Adviser 16 divides each Underlying Index 12 into risk and return characteristics that may include (but are not limited to) one or a multiplicity of: (1) credit rating; (2) sector (e.g., revenue, pre-refunded or insured bonds); (3) issuer (or state of issuer); (4) duration; (5) maturity; (6) coupon yield; and (7) liquidity. Alternatively, none of the above risk and return characteristics may be used. The exact risk and return characteristics can vary widely based on Underlying Index 12 and the needs of Fund 10 as would be apparent by one skilled in the art. Once the Underlying Index 12 has been so divided, each characteristic is treated as if it were a separate Category 18. In further embodiments, each category can then be further divided according to the remaining risk and return characteristics (such as those enumerated above). Once the division process based on the risk and return characteristics is complete, the relatively illiquid securities within each category will be substantially fungible with each other with respect to their performance and impact on the Fund's ability to track the performance of its Underlying Index 12. The categories, when combined, will closely correlate to the characteristics of the Underlying Index 12 as a whole. The breakdown of the Underlying Index 12 into particular categories can vary widely within the spirit of the invention depending on the type of Underlying Index 12 being tracked, as would be readily apparent to one skilled in the art. Such breakdown can therefore occur by any method known in the art, such as those disclosed in Active Index Investing by Steven Schoenfeld (John Wiley, Sons Inc. 2004.)

Conversely, Adviser 16 will also identify certain types of relatively illiquid securities that are ineligible Deposit or Redemption Securities (“Ineligible Securities 24”), which will include certain sectors, issuers and specific relatively illiquid securities, such as NY water bonds.

When completed, the securities that satisfy each Category 18 will be substantially fungible with each other with respect to their performance and impact on Fund's 10 ability to track the performance of Underlying Index 12. Categories 18, when combined, will be designed to closely correlate to the relevant characteristics of Underlying Index 12 as a whole. As discussed below, when creating a Creation Unit, Advisor 16 accepts Component Securities 14, Similar Securities 28 and optionally other financial instruments that represent each Category 18 to create or contribute to a Portfolio 20 of Fund 10. Adviser 16 preferably excludes less liquid relatively illiquid securities in order to create a more tradable Portfolio 20 and improve arbitrage opportunities.

In embodiments using a representative sampling strategy, in addition to investing in some but not all Component Securities 14, Fund 10 may invest in securities that are not included in its Underlying Index 12, but that Adviser 16 deems (based on criteria set forth above regarding the division of each Underlying Index 12 into categories) to have characteristics similar to Component Securities 14 that are represented in such Underlying Index 12, hereinafter called “Similar Securities 28” and further discussed below, such that, they are substantially interchangeable.

Adviser 16 will make available on each business day, i.e., a day on which Fund 10 is open for business, prior to the opening of trading on Fund 10 (i.e., 9:30 a.m. ET), that day's Creation List 32 and Redemption List 62 (discussed below), wherein the Creation List is the list of the names and/or categories and/or the required number of securities for each Deposit Security 22. In certain embodiments, the value of Creation List 32 is based on the net asset value of Fund 10 calculated as of the end of the previous day. Creation List 32 may have all of the same Categories 18 as Portfolio 20 or may only have some of the Categories 18 of Portfolio 20. Thus, the number of Categories 18 on Creation List 32 can vary based on the needs of the Fund. Note that while FIG. 1 shows four Categories, in preferred embodiments, the list can consist of any number of categories, for example between about 4-16 Categories. In further preferred embodiments, the list of Categories 18 is optionally revised on a daily basis. Categories 18 may change to reflect changes in Adviser 16 requirements for Portfolio 20. In this instance, the older Categories 18 are no longer applicable.

In preferred embodiments, the daily Creation List 32 is to be divided into different categories, based on the criteria used in the sampling strategy. Thus, Categories 18 are a grouping of relatively illiquid securities with like characteristics, including rating, coupon and maturity, deemed acceptable by the Fund Manager for use in the Fund's Portfolio 20.

Creation List 32 provides a mechanism for basket unit creation that differs from the mechanism for existing ETFs, because it provides a list of categories representing the securities that will be acceptable as Deposit Securities and a list of categories of securities that will be distributed by Fund 10 upon a redemption (“Fund Securities”), as opposed to a list of specific securities, Deposit Securities and/or Fund Securities. In other words, while other funds require specific securities to form a creation unit or basket without leaving discretion to the user to use a different security, the present invention provides a number of categories wherein a user, or Authorized Participant, has discretion to come up with any type of relatively illiquid security for each category as long as the relatively illiquid security provided meets the relevant category's criteria. In preferred embodiments, to receive a Creation Unit 38, an Authorized Participant must typically contribute one in-kind relatively illiquid security from each category. In further embodiments, more than one type of in-kind relatively illiquid security may be contributed from each category.

Only Authorized Participants 34 may place orders with the Fund's principal underwriter (the “Distributor 44”) and to create Creation Unit(s) 38. Authorized Participant 34 must be a (i) broker-dealer or other participant in the clearing process through the continuous net settlement system of the NSCC or (ii) Depository Trust Company (“DTC”) Participant and preferably, has an executed agreement with Distributor 44, with respect to creations and redemption of Creation Units 38. All shares of Fund 10, however created, will preferably be entered in the records of DTC for the account of the DTC Participant.

Each Fund 10 will reserve the right to reject relatively illiquid securities contributed by an Authorized Participant as Deposit Securities in certain limited circumstances (such as when a materially adverse development has occurred during the business day with respect to a relatively illiquid security's issuer). If a Fund rejects a relatively illiquid security, the Authorized Participant will be required to contribute as a Deposit Security another relatively illiquid security from the same category as the rejected relatively illiquid security.

Thus, to receive Creation Unit 38 based on Creation List 32, Authorized Participant 34 will institute a Creation Order 48 and form a Portfolio Deposit 30 made up of Deposit Securities 22 that are in-kind to each Category 18 in Creation List 32. Each Portfolio Deposit 30 will preferably have one Deposit Security 22 for each Category 18 in Creation List 32. Thus Authorized Participant 34 preferably contributes one relatively illiquid security in-kind to each Category 18 to form a basket of securities. The basket of securities contributed by Authorized Participant 34 will thereby correspond to the characteristics of the applicable Underlying Index 12, as a whole, and facilitate the ability of each Fund 10 to track accurately its respective Underlying Index 12. This basket of securities contribution will facilitate the ability of Authorized Participants 34 to assemble Portfolio Deposit 30, thus, contributing to the effective functioning of the arbitrage process. Such Portfolio Deposit 30 will be applicable, subject to any adjustments to Cash Component 36, in order to effect purchases of Creation Units 38 of Fund 10, until such time as the next-announced Portfolio Deposit 30 composition is made available.

In preferred embodiments using a representative sampling strategy, in addition to investing in some but not all Component Securities 14, Fund 10 accept securities that are not included in its Underlying Index 12, but that Adviser 16 deems (based on criteria set forth above regarding the division of each Underlying Index 12 into categories) to have characteristics similar to Component Securities 14 that are represented in such Underlying Index 12 (Similar Securities 28,) such that, they are substantially interchangeable. Each Portfolio Deposit 30 may contain both Component Securities 14 and Similar Securities 28. There is no set ratio for Component Securities 14 to Similar Securities 28.

Fund 10's use of the representative sampling strategy that includes Similar Securities 28 is necessary and beneficial for a number of reasons, the most important of which is the lack of ready marketability for many relatively illiquid securities. Many relatively illiquid securities, such as municipal bonds, are relatively small issues, and most general obligation bonds are sold on a serial basis, which, in effect, breaks the issues up into smaller components. Furthermore, a large percentage of municipal bonds are purchased by retail investors and small institutions that tend to hold securities to maturity. Overall, bonds issued in smaller offerings and those with thin secondary markets often experience liquidity difficulties and are therefore subject to higher risk. In view of the foregoing, a replication strategy, in and of itself, is not practicable. Moreover, in light of the significant percentage of municipal bonds that are generally not liquid, the use of a representative sampling strategy that allows for the use of more liquid Similar Securities 28 is critical to Adviser 16's ability to develop a Portfolio 20 that is liquid and easy to construct and trade, and thereby allows for effective arbitrage opportunities. In addition, through representative sampling, Adviser 16 can avoid relatively illiquid securities that are “expensive names” (i.e., relatively illiquid securities that trade at perceived higher prices or lower yields, because they are in short supply), but have the same essential risk, value, duration and other characteristics as less expensive names. Such determinations can be made at the Adviser's discretion as is known in the art. Moreover, the use of representative sampling permits Adviser 16 to exclude relatively illiquid securities that it believes will soon be deleted from the Underlying Index 12.

In preferred embodiments, at least 80% of Portfolio 20 will be invested in Component Securities 14 of its respective Underlying Index 12 or Similar Securities 28. Fund 10 may also invest up to 20% of its assets in various other securities and financial instruments, including, but not limited to, variable rate municipal notes, in each case related to its Underlying Index 12 and its Component Securities 14 or Similar Securities 28, as well as cash and cash equivalents.

### EXAMPLE 1

To track the performance of an Underlying Index 12 that has municipal bond Component Securities 14, the following Creation Lists 32 are published that list ten Categories 18 that include risk and return characteristics that represent the Component Securities 14 that Fund 10 is willing to accept.

Short Term Fund:

| | | Effective | | | |
|---|---|---|---|---|---|
| | | Maturity | | | |
| Category 18 | Coupon | Range | Quality | State | Type |
| 1 | 3.5 | 1-1.499 | AA or better | CA | GO |
| 2 | 5.25 | 2.5-2.999 | AA or better | CA | Insured |
| 3 | 5.25 | 3.5-3.999 | AA or better | CA | Revenue |
| 4 | 5 | 4.5-4.999 | AA or better | CA | GO |
| 5 | 5 | 2-2.499 | AA or better | FL | Revenue |
| 6 | 5 | 4-4.499 | AA or better | FL | Insured |
| 7 | 3.15 | 2.5-2.999 | AA or better | NJ | Insured |
| 8 | 5.5 | 4.5-4.999 | AA or better | NY | Insured |
| 9 | 5 | 1-1.499 | AA or better | PR | GO |
| 10 | 5.25 | 4.5-4.999 | AA or better | PR | GO |

Intermediate Term Fund:

| | | Effective | | | |
|---|---|---|---|---|---|
| | | Maturity | | | |
| Category 18 | Coupon | Range | Quality | State | Type |
| 1 | 5 | 9.1-9.2 | AA or better | CA | Insured |
| 2 | 5 | 10.1-10.2 | AA or better | CA | GO |
| 3 | 3.5 | 1.1-1.2 | AA or better | CA | GO |
| 4 | 5 | 16.6-16.7 | AA or better | IL | Revenue |
| 5 | 5.25 | 15.2-15.3 | AA or better | MA | GO |
| 6 | 5 | 4.1-4.2 | AA or better | NJ | GO |
| 7 | 5 | 4.5-4.6 | AA or better | NY | Insured |
| 8 | 5.25 | 5-5.1 | AA or better | NY | Revenue |
| 9 | 5 | 16.5-16.6 | AA or better | NY | Insured |
| 10 | 5 | 1.1-1.2 | AA or better | PR | Revenue |

Authorized Participant 34 wants to put together a basket of securities for a Creation Unit 38 for one of the two funds. Authorized Participant 34 has eight Deposit Securities 22 that match the risk and return characteristics of eight of the Categories. Fund 10 will not accept a Portfolio Deposit unless all Categories 18 are represented. Authorized Participant then requests to include two Similar Securities 28 that are not Component Securities 14 of Underlying Index 12 but still meet the risk and return characteristics of the remaining two categories. If Advisor 16 accepts the Similar Securities, the Authorized Participant can put together a basket of securities, in this case Portfolio Deposit 30, that includes ten Deposit Securities 22, the eight component securities 14 and the two Similar Securities 28. Authorized Participant 34 may also include cash-in-lieu 46. Authorized Participant 34 submits the Portfolio Deposit 30 as part of Creation Order 48 and receives Creation Unit 38. Cash Component 36, discussed below, is also calculated. Fund 10 thereby acquires a contribution to Portfolio 20 due to Portfolio Deposit 30.

Each Deposit Security 22 preferably has a set number of shares per Creation Unit. Creation Units 38 preferably comprise block-size shares of 25,000 or multiples thereof (i.e., 25,000, 50,000, 100,000 etc.). In one preferred embodiment, the Creation List will generally have 10 categories and the Deposit Securities 22 will consist of $1,000,000 round lots to create a Creation Order of $10,000,000. In other preferred embodiments, the precise number of categories and amounts of Deposit Securities 22 can vary widely within the spirit of the invention to suit the needs of the Fund.

Portfolio Deposits 30 are preferably delivered through DTC by an Authorized Participant 34 on a Settlement Date 42. Settlement Date 42 for all Funds is generally the third business day after a Transmittal Date 40, but this can vary, based on the needs of Fund 10. Transmittal Date 40 is the date on which an order to create Creation Units 38 (or an order to redeem Creation Units 38, as discussed below) is placed.

In addition to Creation List 32 (and Redemption List 62,) Adviser 16 will also specify Ineligible Securities 24, which will include certain sectors, issuers and specific bonds. Ineligible Securities 24 are those relatively illiquid securities Adviser 16 deems inconsistent with Fund 10's investment objective or that present unacceptable risk to Fund 10. The investment objective for each Fund 10 is specified in the Fund's prospectus.

Shares of Fund 10 are purchased and created at net asset value (“NAV”) by the Authorized Participants 34. In one embodiment, payment, with respect to Creation Units 38 purchased through Distributor 44, is preferably by the deposit of Deposit Securities 22 and an amount of cash, specified by Adviser 16, in the manner described below (the “Cash Component 36”). In addition to the Cash Component 86, each Deposit Security 22 may contain both or either Component Securities 14 and Similar Securities 28.

Cash Component 36 is an amount equal to the difference between (1) net asset value (NAV) (per Creation Unit 38) of Fund 10 and (2) the total aggregate market value (per Creation Unit 38) of Deposit Securities 22 (such value referred to herein as the “Deposit Amount”). Cash Component 36 serves the function of compensating for differences, if any, between the NAV per Creation Unit 38 and that of the Deposit Amount. The market value of Deposit Securities 22 is determined at the same time of Fund 10's NAV, calculated utilizating the same valuation methodology.

If Cash Component 36 is a positive number (i.e., if the NAV per Creation Unit 38 exceeds the Deposit Amount), the creator will deliver Cash Component 36 to Distributor 44. If Cash Component 36 is a negative number (i.e., the NAV per Creation Unit 38 Aggregation is less than the Deposit Amount), the creator will receive Cash Component 36 from Distributor 44.

Creation Units 38 of Fund 10 may be created in advance of receipt by Fund 10 of all or a portion of the applicable Deposit Securities 22. In these embodiments, the initial deposit will have a value greater than the NAV of the shares on the date the order is placed in proper form since, in addition to available Deposit Securities 22, cash must be deposited in an amount equal to the sum of (i) Cash Component 36, plus (ii) at least 105% of the market value of the undelivered Deposit Securities 22 (the “Additional Cash Deposit”).

Fund 10 issues and sells shares in Creation Unit 38 on a continuous basis through a Distributor 44 of Fund 10. Creation Units 38 are preferably issued without a sales load. In one embodiment, the Shares of Fund 10 will be issued and redeemed in groups of 25,000 or multiples thereof, each a Creation Unit. Thus a creation and redemption basket will generally equal approximately $10 million (approximately a basket of 10 relatively illiquid securities). This enables an Authorized Participant 34 to execute ten relatively illiquid security trades at the typical institutional minimum round lot size of $1 million.

In further preferred embodiments, Fund 10 will reserve the right to permit or require the substitution of a “Cash-In-Lieu” 46 amount to be added to Cash Component 36 to replace any Deposit Security that may not be available in sufficient quantity for delivery or that may not be eligible for transfer through the DTC for relatively illiquid securities, or if Authorized Participant 34 requests the use of Cash-In-Lieu 46 when entering a Creation Order 48. Fund 10 will also reserve the right to permit Cash-In-Lieu 46 amount for any reason. Fund 10 may require Cash-In-Lieu 46 amount to replace any Deposit Security of the Creation Unit Aggregation that is a TBA transaction. The amount of cash contributed will be equivalent to the price of the TBA transaction listed as a Deposit Security.

The amount of cash equal to Cash Component 36 or any Cash-In-Lieu 46 component is preferably transferred directly to Fund 10's custodian bank through a Federal Reserve Bank wire transfer system, preferably on the next Business Day following Transmittal Date 40. If Cash Component 36 and Deposit Securities 22 are not received by a predesignated time, the order may be cancelled. Upon written notice of Distributor 44, such cancelled orders may be resubmitted the following Business Day using a Fund Deposit 52 as newly constituted to reflect the then current NAV of Fund 10.

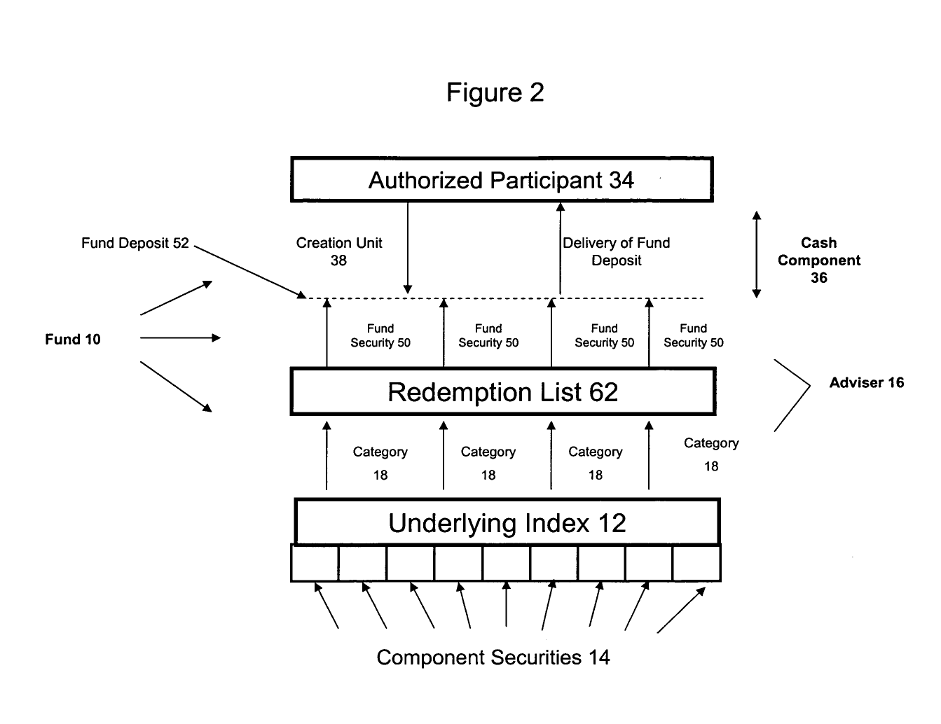

As shown in FIG. 2, the procedures for the redemption of Creation Units 38 are identical to those for the creation of Creation Units 38 of the Funds 10, except as noted below.

Shares can only be redeemed by Authorized Participant 34, either for cash, for one or more specified relatively illiquid securities, or a combination thereof. Except when aggregated in Creation Units 38, shares are not individually redeemable. The prices at which creations and redemptions occur are based on the next calculation of NAV after an order is received in a form described in the Authorized Participant agreement. Preferably such a process includes a Redemption Order 54.

A daily list of categorized securities eligible to be received, in respect of a redemption of Creation Units 38 is published in “Redemption List 62”. Redemption List 62 is a list divided of different categories, based on the same criteria set forth for purchase of Creation Units 38. The Redemption List 62, however, may not be the same as Creation List 32. When an Authorized Participant 34 redeems a Creation Unit 38, Fund 10 provides a Fund Deposit 52 made up of a multiplicity of Fund Securities 50 that correspond to the risk and return characterizes of Redemption List 62. In determining Fund Securities 50 and the order in which they are listed within each Category 18, wherein Fund Securities 50 are securities delivered to Authorized Participant 34 by Fund 10 on redemption of Creation Unit 38, Adviser 16 will seek to construct a redemption basket that will reflect the general characteristics of Fund 10 Portfolio 20. Fund Securities 50 may or may not be identical to Deposit Securities 22. Further, Fund Securities 50 may contain either or both Component Securities 14 and Similar Securities 28. Upon each request for a redemption of Creation Units 38, Adviser 16 will allocate a first relatively illiquid security on the list from each Category 18 (as of the time such redemption request is received by the Transfer Agent) to Authorized Participant 34 to receive in-kind. Authorized Participant 34 will also receive a Cash Component Payment calculated, in the same manner, as Cash Component 36. As with respect to the purchase of Creation Units 38, each Fund 10 will reserve the right to substitute Cash-In-Lieu 46 amount to be added to the Cash Redemption Payment to replace any Fund Security that may not be available in sufficient quantity for delivery or that may not be eligible for transfer through the DTC for relatively illiquid securities. Fund 10 will also reserve the right to substitute Cash-In-Lieu 46 amount for any reason.

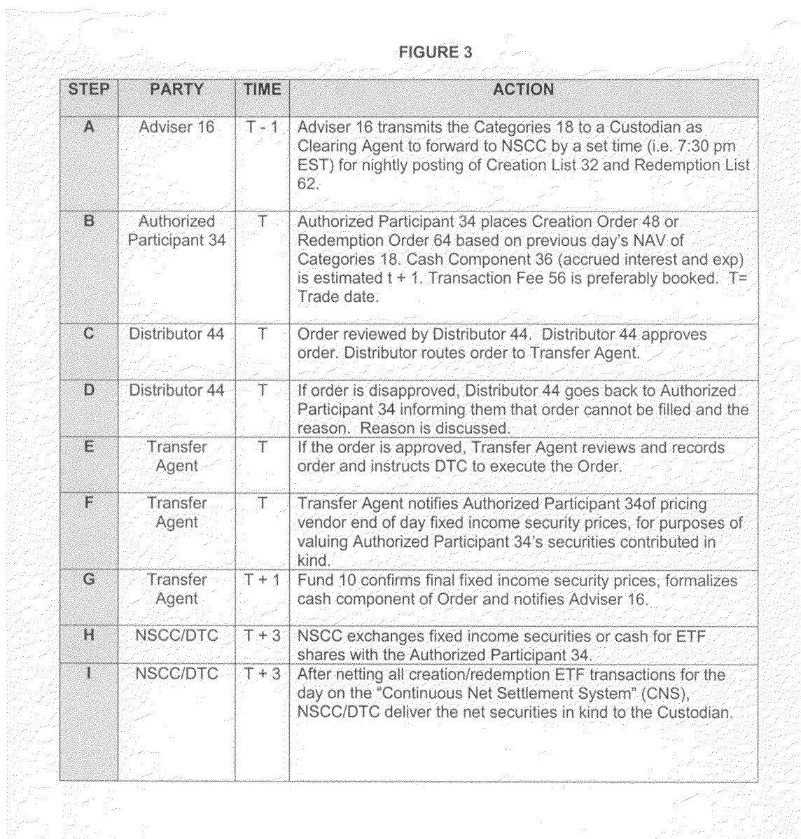

As shown in FIG. 3, all orders to create or redeem Creation Units 38 of Fund 10 are preferably received no later than set time, for example, 4 p.m. Eastern time, on the date such order is placed in order for creation or redemption of Creation Units 38 to be effected, based on the NAV of shares of such Fund 10 as next determined on such date after receipt of the order in proper form. On days when an Exchange or the bond markets close earlier than normal, Fund 10 may require orders to create or redeem Creation Units 38 to be placed earlier in the day. Orders for the purchase of shares of the Funds 10 are preferably not to be accepted on any day when the fixed income markets are closed, although exceptions can be made. Orders must be transmitted by an Authorized Participant 34 by telephone, internet or other transmission method acceptable pursuant to procedures set forth in the Participant Agreement.

In the event of the failure to deliver the missing Deposit Securities 22, Fund 10 may buy securities according to industry standards and procedures. Authorized Participants 34 will be liable to Fund 10 for the costs incurred by Fund 10 in connection with any such purchases. These costs will be deemed to include the amount by which the actual purchase price of Deposit Securities 22 exceeds the market value of such Deposit Securities 22, on the day the purchase order was deemed received by Distributor 44, plus, the brokerage and related transaction costs associated with such purchases. The Trust will return any unused portion of the Additional Cash deposit once all of the missing Deposit Securities 22 have been properly received by Fund 10's Bank or purchased by Fund 10 and deposited into Fund 10. In addition, a Transaction Fee 56 may be charged. The delivery of Creation Units 38 will preferably occur no later than Settlement Date 42.

As further shown in FIG. 3, Fund 10 preferably reserves the right to reject or revoke acceptance of a Creation Order 48 transmitted to it by Distributor 44 if, for example (i) the order is not in proper form; (ii) the investor, upon obtaining the shares ordered, would own 80% or more of the currently outstanding shares of Fund 10; (iii) Deposit Securities 22 delivered do not conform to the relevant Category 18 description, as disseminated through the facilities for that date; (iv) acceptance of Deposit Securities 22 would have certain adverse tax consequences to Fund 10; (v) acceptance of the Fund Deposit 52 would, in the opinion of counsel, be unlawful; (vi) acceptance of the Fund Deposit 52 would otherwise, in the discretion of Fund 10, have an adverse effect on Fund 10 or the rights of beneficial owners; or (vii) in the event that circumstances outside the control of Fund 10 would make it, for all practical purposes, impossible to process Creation Orders 48.

Transaction expenses, including operational processing and brokerage costs, may be incurred when Authorized Participants 34 purchase or redeem Creation Units 38 “in-kind”. Such expenses have the potential to dilute the interests of each Fund 10's existing shareholders. Hence, in preferred embodiments, purchase or redemption transaction fees 56 (“Transaction Fees”) will be imposed, in connection with effecting such purchases or redemptions. In further preferred embodiments, where Fund 10 permits an Authorized Participant 34 to substitute Cash-In-Lieu 46 of depositing one or more of the requisite Deposit Securities 22, Authorized Participant 34 may be assessed a higher Transaction Fee 56 on Cash-In-Lieu 46 portion of its investment to cover the cost of purchasing such Deposit Securities 22, including operational processing and brokerage costs, and part or all of the spread between the expected bid and offer side of the market relating to such Deposit Securities 22. The precise cost of the Transaction Fee 56 can vary widely and/or be adjustable within the spirit of the invention.

Clearance and settlement of redemption transactions essentially reverses the creation process. After Fund 10 has received a redemption request in proper form and Authorized Participant 34 transfers Creation Units 38 to Adviser 16 through DTC, Fund 10 will cause Adviser 16 to initiate procedures to transfer the requisite Fund Securities 50 and any cash redemption payment. On Settlement Date 42, assuming Adviser 16 has verified receipt of Creation Units 38, Adviser 16 will transfer Fund Securities 50 to Authorized Participant 34 through DTC and any cash redemption payment through the Federal Reserve system. Creation Units 38 of Fund 10 will preferably be debited or credited by Adviser 16 directly to the DTC accounts of the Authorized Participants 34.

Fund 10 can further include other features known in the art. For example, an Intra-day Optimized Portfolio Value or “IOPV” 60 can be calculated by an independent third-party pricing service at set intervals.

Fund 10 may be implemented in any manner known in the art, including electronic trading or other types of trading. In preferred embodiments, Fund 10 is implemented on a computer system 58 or like product, where in computer system 58 is preferably networked to other computer systems through internet connections, wherein the computer system includes a computer storage medium storing a computer program product and/or including computer programming for performing the actions required to run Fund 10. This includes, but is not limited to, allowing Creation Units 38 to be formed and redeemed over the internet by Authorized Participants 34.

One skilled in the art will understand that the invention provides a Fund that includes securities that are not Component Securities in the universe of securities eligible for inclusion as Deposit Securities or Fund Securities, and affords Authorized Participants the flexibility to designate securities within each category for inclusion in the Portfolio Deposit. This approach is necessitated by the substantial number of relatively illiquid securities such as municipal bonds that lack sufficient liquidity for easy assembly in the amounts necessary for the in-kind creation or redemption of Creation Units for typical ETFs. This approach should facilitate the ability of Authorized Participants to assemble a Portfolio Deposit and thereby allow for the effective functioning of the arbitrage process, while simultaneously enhancing the ability of the Adviser to track the applicable Underlying Index.

A number of embodiments of the present invention have been described. Nevertheless, it will be understood that various modifications may be made without departing from the spirit and scope of the invention. Further note that the capitalized and un-capitalized versions of terms regarding this invention are generally interchangeable.

What is claimed is:

1. A process to facilitate in-kind creation and redemption of shares of an ETF which seeks to replicate the performance of an index or indices comprised substantially of relatively illiquid securities, comprising the steps of:
(a) identifying an underlying index or indices having a multiplicity of relatively illiquid component securities,
(b) assigning risk and return characteristics to the relatively illiquid component securities,
(c) creating a list of categories, the categories each generally corresponding to a representative subset of component securities having like risk and return characteristics, and
(d) exchanging one or a multiplicity of Creation Units for a basket of securities, wherein the risk and return characteristics of the basket of securities for each Creation Unit comprise individual securities that meet the risk and return characteristics of an individual category such that all of the categories are represented in the basket of securities.

2. The process of claim 1, wherein the step of exchanging one or a multiplicity of Creation Units for a basket of securities creates the one or a multiplicity of Creation Units.

3. The process of claim 1, wherein the step of exchanging one or a multiplicity of Creation Units for a basket of securities redeems the one or a multiplicity of Creation Units.

4. The process of claim 2, wherein the step of exchanging one or a multiplicity of Creation Units for a basket of securities is an exchange of one or a multiplicity of Creation Units for a portfolio deposit comprising a multiplicity of deposit securities.

5. The process of claim 3, wherein the step of exchanging one or a multiplicity of Creation Units for a basket of securities is an exchange of the one or a multiplicity of Creation Units for a fund deposit comprising a multiplicity of fund securities.

6. The process of claim 2, wherein the list is a published creation list, the creation list comprising a multiplicity of categories describing the risk and return characteristics of securities eligible to be received, in respect of a creation of the one or a multiplicity of Creation Units.

7. The process of claim 3, wherein the list is a published redemption list, the redemption list comprising a multiplicity of categories describing the risk and return characteristics of securities eligible to be recieved, in respect the redemption of the one or a multiplicity of Creation Units.

8. The process of claim 1, wherein the basket of securities includes similar securities, wherein the similar securities are securities from outside the underlying index or indices and having characteristics similar to securities that are represented in the underlying index or indices.

9. The process of claim 1, wherein the exchange further comprises a Cash Component.

10. The process of claim 1, wherein the list includes about 4-16 categories.

11. The process of claim 1, wherein the relatively illiquid component securities are selected from the list consisting of municipal bonds, ABS, 144As, MSS, CDOs, and CLOs.

12. The process of claim 1, wherein the one or a multiplicity of Creation Units are issued and redeemed in groups of 25,000 shares or multiples thereof.

13. The process of claim 1, wherein the risk and return characteristics are selected from the list consisting of, credit rating, sector, issuer, duration, maturity, coupon yield and liquidity.

14. A process to facilitate in-kind creation and redemption of shares of an ETF which seeks to replicate the performance of an index or indices comprised substantially of relatively illiquid securities, comprising the steps of: determining a multiplicity of categories based on risk and return characteristics of relatively illiquid securities, exchanging one relatively illiquid security contribution from each category, each relatively illiquid security having in-kind risk and return characteristics as the corresponding category.

15. The process of claim 14, wherein the step of determining a multiplicity of categories based on risk and return characteristics of relatively illiquid securities comprises categorizing component securities of an Underlying Index.

16. The process of claim 14, wherein relatively illiquid security contributions are deposit securities, and the step of exchanging one relatively illiquid security contribution from each category comprises exchanging the deposit securities for a Creation Unit.

17. The process of claim 14, wherein the relatively illiquid security contributions are fund securities, and the step of exchanging one relatively illiquid security contribution from each category comprises redeeming a Creation Unit for fund securities.

18. The process of claim 14, wherein the relatively illiquid security contribution includes component securities and similar securities.

19. The process of claim 19, wherein the relatively illiquid component securities are selected from the list consisting of municipal bonds, ABS, 144As, MSS, CDOs, and CLOs.

20. A fund for facilitating in-kind creation and redemption of shares of an Exchange traded Fund, the fund comprising shares related to a multiplicity of categories based on risk and return characteristics of relatively illiquid component securities.
